(19) United States
(12) Patent Application Publication
(10) Pub. No.: US 2020/0039090 A1
(43) Pub. Date: Feb. 6, 2020

(54) HOLDING DEVICE FOR FOODS

(71) Applicant: KAWASAKI JUKOGYO KABUSHIKI KAISHA, Kobe-shi, Hyogo (JP)

(72) Inventors: Kenji BANDO, Nishinomiya-shi (JP); Kazunori HIRATA, Yao-shi (JP)

(73) Assignee: KAWASAKI JUKOGYO KABUSHIKI KAISHA, Kobe-shi, Hyogo (JP)

(21) Appl. No.: 16/340,277

(22) PCT Filed: Oct. 5, 2017
(86) PCT No.: PCT/JP2017/036256

§ 371 Date: Apr. 8, 2019

(30) Foreign Application Priority Data
Oct. 7, 2016 (JP) 2016-199017

(51) Int. Cl. B25J 15/00; B65B 5/08; B65B 25/00; B65B 35/36; B25J 9/02

(52) U.S. Cl. CPC B25J 15/0042; B65B 5/08; B25J 9/02; B65B 35/36; B65B 25/001

(57) ABSTRACT

A holding device for foods is configured to hold self-standable foods each having a front surface and a rear surface parallel to the front surface. The holding device for the foods includes a holding part configured to hold the foods in a standing state where the front surfaces face in a first direction and in a state where the foods are lined up in the first direction. The holding part includes a plurality of pairs of holding members each configured to pinch each of the foods from both sides in the first direction, and actuator members each configured to independently operate each of the pairs of holding members.

### TECHNICAL FIELD

The present disclosure relates to a holding device for foods.

### BACKGROUND ART

Conventionally, devices which pack foods into a container, such as a tray (see Patent Documents 1 to 3) are known. A container packing device for foods disclosed in Patent Document 1 drops foods in a given posture from a conveyor onto a conveying part, and sequentially packs the foods into a container so that the foods are stacked side by side while maintaining a standing posture. This container packing device for foods can pack foods, such as rice balls and sandwiches, into the container. Such food is easy to be deformed and, once the food is deformed by an external force, it will not resume its original shape even if the external force is removed. Thus, if the food is deformed by the external force when the food falls, the commodity value of food will be reduced by the deformation. As a result, a rate of nonconforming products may increase to reduce the efficiency of work.

Patent Documents 2 and 3 disclose box packing devices which pack a plurality of foods while holding the foods. The box packing device disclosed in Patent Document 2 sucks and holds foods (cucumbers) at a front row and a rear row arrayed in two line-up trays by suction pads, respectively, and supports the foods (cucumbers) in a posture in which rear ends of the foods incline slightly downward. The device then packs the foods (cucumbers) at the front row and the foods (cucumbers) at the rear row sucked and held by the respective suction pads so that they are overlapped with each other at their longitudinal end parts. The box packing device disclosed in Patent Document 3 lifts a plurality of foods (rice balls) by a suction unit, moves the lifted foods above a given packing position and lowers the foods, and stops the suction to pack the foods in a box. As another conventional art, Patent Document 4 discloses a robotic hand which holds at once a plurality of foods conveyed from a previous process by a conveying device, such as a belt conveyor, and transfers them to a subsequent process. This robotic hand is provided in an upper part thereof with a long frame extending in one way, a plurality of gripper supports fixed to a base plate are suspended below the frame at an equal interval, and a workpiece gripper is provided to a lower end of each gripper support.

### REFERENCE DOCUMENTS OF CONVENTIONAL ART

### Patent Documents

[Patent Document 1] JP1994-024408A

[Patent Document 2] JP1994-071404U

[Patent Document 3] JP 2011-251702A

[Patent Document 4] JP2001-198871A

### DESCRIPTION OF THE DISCLOSURE

### Problems to be Solved by the Disclosure

However, the box packing device of Patent Document 2 is capable of holding only two foods (cucumbers) at once. Thus, if this box packing device is used for packing foods, such as rice balls and sandwiches, into a container, the productivity may be lowered.

Moreover, although the box packing device of Patent Document 3 and the robotic hand of Patent Document 4 can hold a plurality of (six) foods at once, since they hold the foods stacked side by side, there is a problem that a large workspace is needed to perform the packing work of the foods.

The present disclosure is made in view of addressing the above problems, and one purpose thereof is to increase an efficiency of a packing work of foods within a limited workspace.

### Summary of the Disclosure

In order to achieve the purpose, a holding device for foods according to one aspect of the present disclosure, which holds self-standable foods each having a front surface and a rear surface parallel to the front surface, includes a holding part configured to hold the foods in a standing state where the front surfaces face in a first direction and in a state where the foods are lined up in the first direction. The holding part includes a plurality of pairs of holding members each configured to pinch each of the foods from both sides in the first direction, and actuator members each configured to independently operate each of the pairs of holding members. Note that the term “self-standable” means that the food is able to stably stand still in a state where the mutually-parallel front surface and rear surface are oriented in the vertical direction. Moreover, regarding the front surface and the rear surface of the food being oriented in the vertical directions or mutually parallel, the phrase is not intended to limit them to the exactly vertical direction or mutually parallel, but to permit a slight inclination caused by the surface of the food or wrapping of the food.

According to the above structure, by the plurality of pairs of holding members each operating independently so as to pinch each of foods from both sides in the first direction, the foods can be certainly held in the state where the foods are line up in the first direction. Thus, the efficiency of the packing work of the foods can be improved in the limited workspace.

The holding device may further include a base and a robotic arm configured to be movable with respect to the base, and provided at a tip end thereof with the holding part. The holding device may hold the foods in the state where the foods are lined up in the first direction by repeating, in a workspace of the robotic arm, a holding operation by each of the pairs of holding members to the each of the foods lined up in a second direction perpendicular to the first direction in the standing state where the front surfaces face in the first direction. The phrase “lined up in the direction perpendicular to the first direction” as used herein is not intended to limit the direction to the strict perpendicular direction, but to permit a positional deviation or a slight inclination of the food caused by the surface of the food or wrapping of the food.

According to the above structure, the foods can be certainly held in the state where the foods are lined up in the first direction, by repeating the holding operation by each of the pairs of holding members for each food lined up in the second direction perpendicular to the first direction in the standing state where the front surfaces face in the first direction.

### Effect of the Disclosure

The present disclosure has the structure described above and has the effect of increasing the efficiency of the packing work of the foods within the limited workspace.

### BRIEF DESCRIPTION OF DRAWINGS

FIG. 1 is a plan view schematically illustrating the entire structure of a holding device for foods according to one embodiment of the present disclosure.

FIG. 2 is a perspective view schematically illustrating the foods of FIG. 1.

FIG. 3 is a front view schematically illustrating the entire structure of one example of a robot of FIG. 1.

FIGS. 4(A) and 4(B) are views illustrating a structure of a hand part (holding part) of the robot of FIG. 3.

FIG. 5 is a functional block diagram schematically illustrating a structure of a control device of the robot of FIG. 3.

FIG. 6 is a perspective view illustrating a first holding operation of the foods.

FIG. 7 is a perspective view illustrating a second holding operation of the foods.

FIG. 8 is a perspective view illustrating a third holding operation of the foods.

FIGS. 9(A) and 9(B) are views illustrating a modification of the structure of the hand part (holding part) of the robot of FIG. 4.

### MODES FOR CARRYING OUT THE DISCLOSURE

Hereinafter, a desirable embodiment is described with reference to the drawings. Note that, in the following, the same or corresponding elements are denoted by the same reference characters throughout the drawings to omit redundant description. Moreover, the drawings are to illustrate each element schematically in order to facilitate understandings. Further, a direction in which a pair of arms is extended is referred to as the “left-and-right direction,” a direction parallel to an axial center of a base shaft is referred to as the “up-and-down direction,” and a direction perpendicular to the left-and-right direction and the up-and-down direction is referred to as the “front-and-rear direction.”

### (Embodiment)

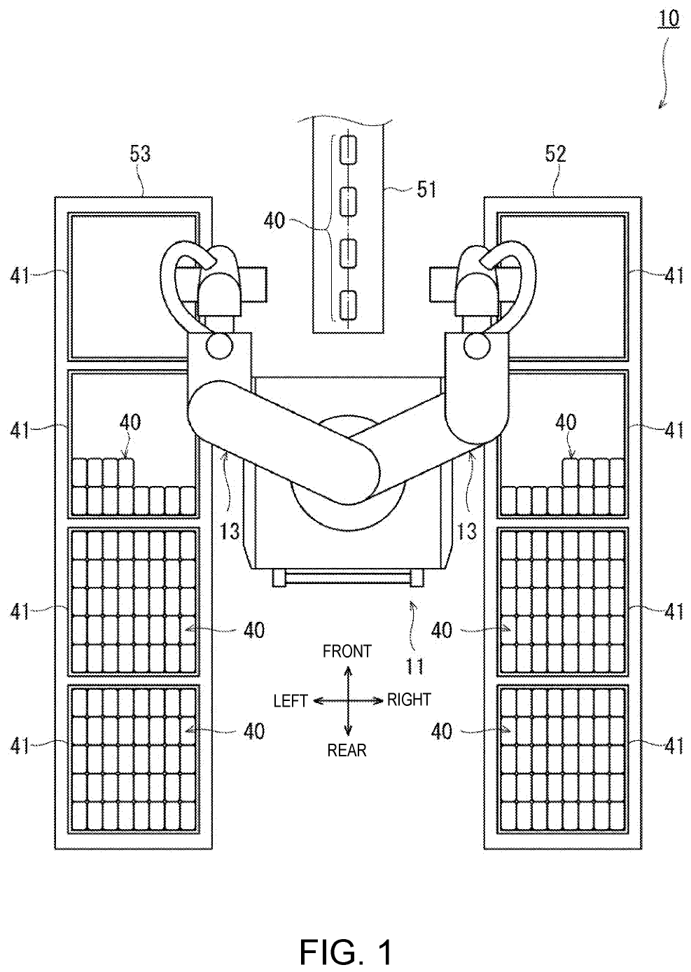

FIG. 1 is a plan view schematically illustrating the entire structure of a holding device 10 for foods 40 according to one embodiment of the present disclosure. As illustrated in FIG. 1, the holding device 10 for the foods 40 is used for a packing work of a plurality of foods 40 into a tray 41. In this embodiment, a case where the holding device 10 for the foods 40 according to the present disclosure is comprised of a robot 11 will be described. The robot 11 includes a pair of robotic arms 13. Note that the holding device 10 for the foods 40 is not limited to the case where it is comprised of the robot 11. Note that, although a case where the robot 11 is a horizontal articulated dual-arm robot will be described, a horizontal articulated robot or a vertical articulated robot may be adopted. The robot 11 may be installed in a limited space (e.g., 610 mm×620 mm) corresponding to one person.

A first belt conveyor 51 is disposed in front of the robot 11. A second belt conveyor 52 and a third belt conveyor 53 are disposed at the right and left sides of the robot 11. In this embodiment, a “workspace” of the pair of robotic arms 13 is a space which covers, in a front view, a part of the first belt conveyor 51 on the robot 11 side, and the second belt conveyor 52 and the third belt conveyor 53. The first belt conveyor 51 is a device for transferring the foods 40 from a location in front of the robot 11 to near the robot 11, and is extended in the front-and-rear direction. The second belt conveyor 52 is a device which extends in the front-and-rear direction and transfers the trays 41 from the right side of the robot 11 to the right rear side. The third belt conveyor 53 is a device which extends in the front-and-rear direction and transfers the trays 41 from the left side of the robot 11 to the left rear side. Moreover, although in this example each tray 41 is a container which can store 40 pieces of foods (eight columns×five rows) 40, the storage capacity of the tray 41 is not limited to this capacity. Other containers may also be applicable if the containers open upwardly.

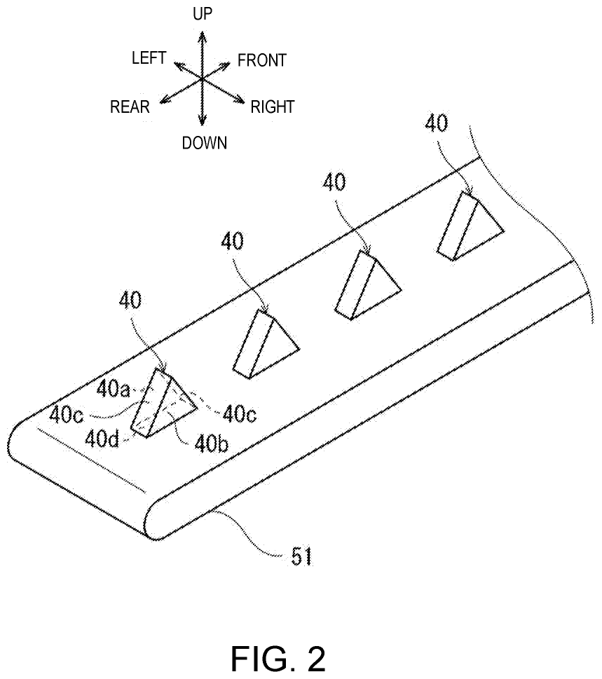

Each food 40 is a food product having a fixed shape, and for example, the food 40 may be a rice ball or a sandwich. FIG. 2 is a perspective view schematically illustrating the foods 40 in FIG. 1. As illustrated in FIG. 2, the food 40 is self-standable, and has a front surface 40a, and a rear surface 40b parallel to the front surface 40a. Note that the term “self-standable” means that the food 40 is able to stably stand still in a state where the mutually-parallel front surface 40a and rear surface 40b are oriented in the vertical direction. Moreover, regarding the front surface 40a and the rear surface 40b of the food 40 being oriented in the vertical directions or mutually parallel, the phrase is not intended to limit them to the exactly vertical direction or mutually parallel, but to permit a slight inclination caused by the surface of the food 40 or wrapping of the food 40. In this embodiment, a triangular rice ball wrapped with a film is used as the food 40. Normally, although the film-wrapped rice ball has a film portion projected from an upper part for easier opening of the film, the film upper part is not illustrated here.

An outer surface of the food 40 has two triangular planes (the front surface 40a and the rear surface 40b) and three rectangular planes (side surfaces 40c on both sides, and a bottom surface 40d). In this embodiment, the foods 40 are each conveyed on the first belt conveyor 51, in the standing state where the front surface 40a faces in a first direction and in a state where the foods 40 are lined up in a second direction perpendicular in the first direction. The phrase “lined up in the direction perpendicular to the first direction” as used herein is not intended to limit the direction to the strict perpendicular direction, but to permit a slight inclination caused by the surface of the food 40 or wrapping of the food 40, or the positional deviation of the food 40 when the food 40 is placed on the belt conveyor.

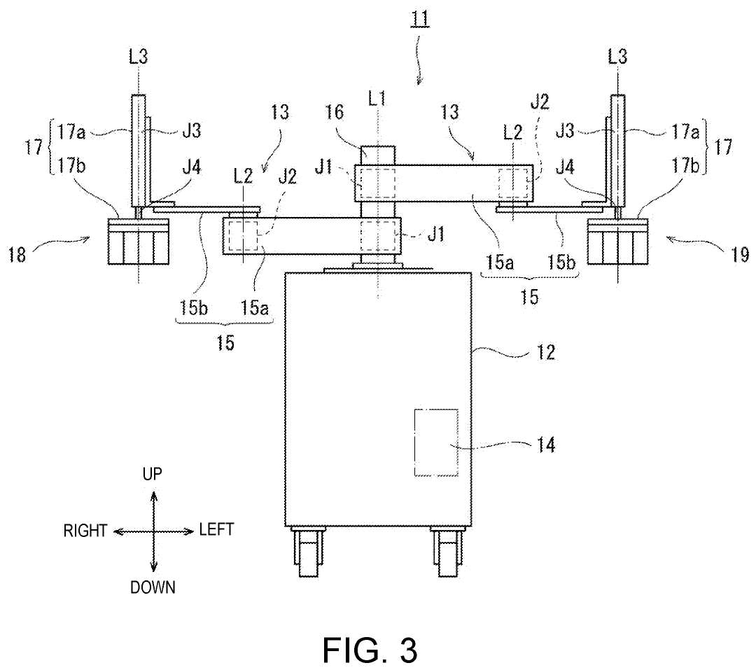

FIG. 3 is a plan view schematically illustrating the entire structure of one example of the robot 11. As illustrated in FIG. 3, the robot 11 includes a base 12 fixed to a carriage, the pair of robotic arms (hereinafter, may simply be referred to as the “arms”) 13 supported by the base 12, and a control device 14 accommodated in the base 12. Each arm 13 is a horizontal articulated robotic arm which is movable with respect to the base, and is provided with an arm part 15, a wrist part 17, and a hand part 18 or 19. Note that the right arm 13 and the left arm 13 may have substantially the same structures. Moreover, the right arm 13 and the left arm 13 are capable of operating independently from each other or collaboratively with each other.

In this example, each arm part 15 is comprised of a first link 15a and a second link 15b. The first link 15a is coupled to a base shaft 16 fixed to an upper surface of the base 12 via a rotary joint J1, and is rotatable on a rotation axis L1 passing through an axial center of the base shaft 16. The second link 15b is coupled to a tip end of the first link 15a via a rotary joint J2, and is rotatable on a rotation axis L2 defined at the tip end of the first link 15a.

The wrist part 17 is comprised of an elevating part 17a and a rotary part 17b. The elevating part 17a is coupled to a tip end of the second link 15b via a linear-motion joint J3, and is capable of ascending and descending with respect to the second link 15b. The rotary part 17b is coupled to a lower end of the elevating part 17a via a rotary joint J4, and is rotatable on a rotation axis L3 defined at the lower end of the elevating part 17a.

The right hand part 18 and the left hand part 19 are coupled to the rotary parts 17b of the wrist parts 17, respectively. The right hand part 18 is provided at a tip end of the right arm 13. The left hand part 19 is provided at a tip end of the left arm 13. Note that the right hand part 18 and the left hand part 19 correspond to a “holding part” of the present disclosure.

Each arm 13 having the above structure includes the joints J144. The arm 13 is provided, corresponding to the joints J144, with driving servo motors (not illustrated) and encoders (not illustrated) which detect rotational angles of the servo motors, respectively. The rotation axes L1 of the first links 15a of the two arms 13 are located coaxially. The first link 15a of one arm 13 and the first link 15a of the other arm 13 are provided with a height difference therebetween.

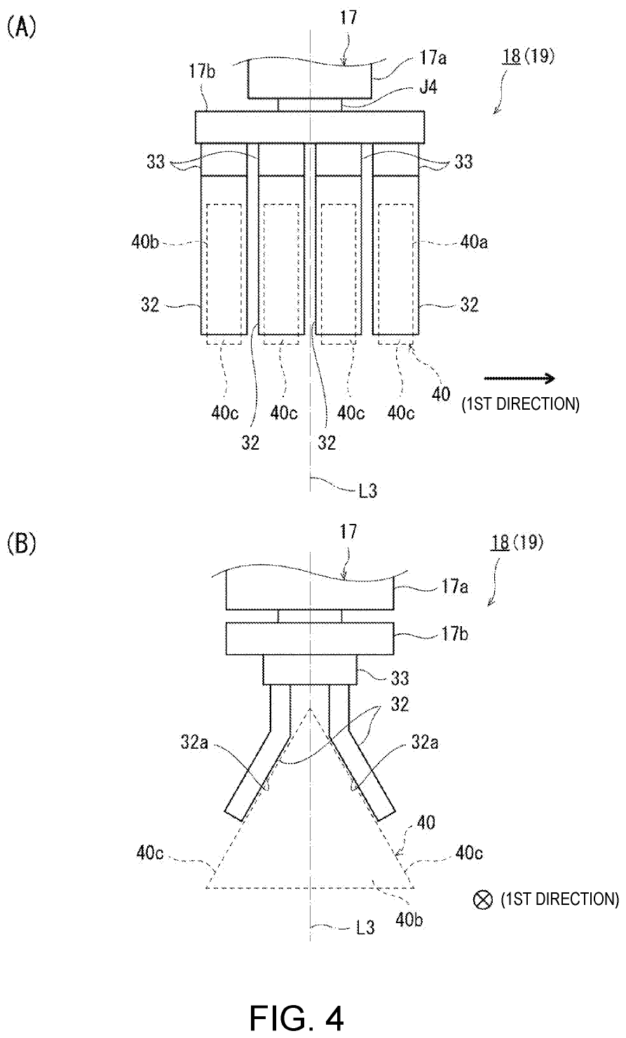

FIGS. 4(A) and 4(B) are a front view and a side view illustrating the structure of the right hand part 18 (holding part) of FIG. 3, respectively. Note that, since the left hand part 19 has the same structure as the right hand part 18, only the structure of the right hand part 18 is described herein. As illustrated in FIG. 4(A), the right hand part 18 is constructed so that it can hold four pieces of the foods 40 in the standing state which are lined up in the first direction with the front surfaces 40a of the foods 40 being oriented in the first direction. The first direction is a direction from the left to the right in the drawing sheet of FIG. 4(A). In FIG. 4(B), the first direction is a direction toward the drawing sheet from a viewer. The right hand part 18 has four pairs of holding members 32 lined up in the first direction, and four actuator members 33 which can independently operate the four pairs of holding members 32, respectively. The rotary part 17b of the wrist part 17 extends in the horizontal direction perpendicular to the rotation axis L3 in the front view. Each holding member 32 is connected with the rotary part 17b of the wrist part 17 via the actuator member 33.

Each pair of holding members 32 is constructed so as to pinch the food 40 from both sides, in the standing state where the front surface 40a faces in the first direction. In this embodiment, each pair of holding members 32 is constructed so as to pinch the side surfaces 40c of the food 40 from both sides. Each holding member 32 has a contact surface 32a which has a shape conforming to the inclination of the side surface 40c of the food 40, and contacts the food 40. The holding member 32 may have, for example, a rectangular flat-plate shape and has two opposite flat primary surfaces, and one of the primary surfaces is the contact surface 32a which contacts the food 40 held by the holding members 32. For example, a resin plate or a metal plate may be used for the material of the holding member 32. In this embodiment, since a triangular-shaped rice ball is used as the food 40, each pair of holding members 32 is arranged so as to form a mountain shape (an inverted V-shape) in which a mutual gap is narrowed toward upper end parts and spreads downwardly.

The actuator member 33 operates the pair of holding members 32. The actuator member 33 is connected to an actuator (not illustrated) etc., and is connected to the upper end side of the pair of holding members 32 so that it moves linearly to change the mutual gap of the pair of holding members 32. By this actuator member 33, the pair of holding members 32 reduce the mutual gap to pinch and hold one piece of food 40. Although in this embodiment each food 40 is held by a frictional force generated when the contact surfaces 32a of the holding members 32 contact the side surfaces 40c of the food 40, suction port(s) may be formed in the contact surface 32a to hold the food 40 by a suction force.

Note that, in this embodiment, the gap is formed at the upper parts of the left and right holding members 32 when the food 40 is held. Thus, the holding members 32 do not touch the film upper part of the rice ball (40). Normally, in the rice ball wrapped with the film, since the film upper part is made easier to be torn by forming perforations etc. for an easier opening of the film, the above structure will neither accidentally open the food 40, nor damage the food 40.

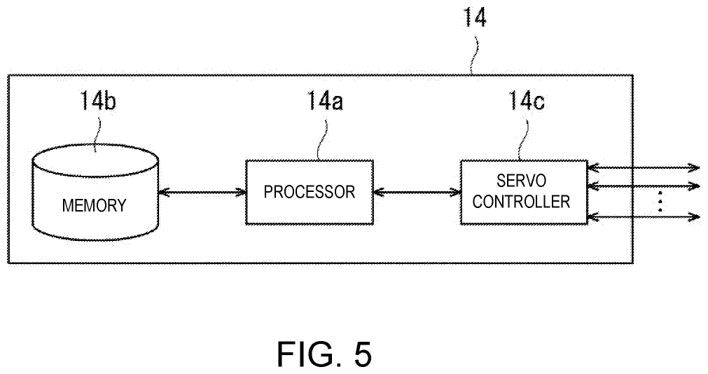

FIG. 5 is a functional block diagram schematically illustrating a configuration of the control device 14 of the robot 11 in FIG. 3. As illustrated in FIG. 5, the control device 14 includes a processor 14a, such as a CPU, a memory 14b, such as a ROM and/or a RAM, and a servo controller 14c. The control device 14 is a robot controller provided with a computer, such as a microcontroller, for example. The control device 14 may be comprised of a single control device 14 which carries out a centralized control. Alternatively, the control device 14 may be comprised of a plurality of control devices 14 which collaboratively carry out a distributed control.

The memory 14b stores information, such as a basic program as the robot controller, various fixed data, etc. The processor 14a controls various operations of the robot 11 by reading and executing software, such as the basic program, stored in the memory 14b. That is, the processor 14a generates a control command of the robot 11, and outputs the command to the servo controller 14c. The servo controller 14c controls driving of the servo motors corresponding to the joints J144 of each arm 13 of the robot 11 based on the control command generated by the processor 14a.

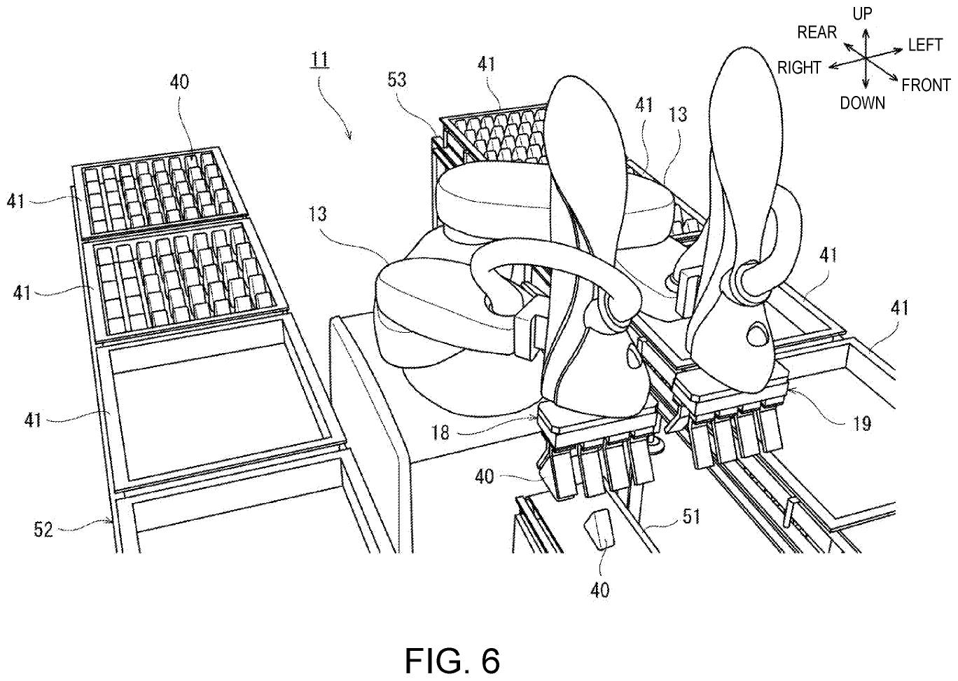

Next, holding operations of the foods 40 in this embodiment are described with reference to FIGS. 6 to 8. Since operations of the left and right arms of the robot 11 are the same, the operations of the right hand part 18 (holding part) are described herein. In this embodiment, the foods 40 are conveyed in a line on the first belt conveyor 51, in the standing state where the front surfaces 40a faces in the first direction and in a state where the foods 40 are lined up in the second direction perpendicular to the first direction. Here, the first direction is the left-and-right direction and the second direction is the front-and-rear direction. Moreover, the perpendicular direction is not limited to the strict perpendicular direction, but permits a slight inclination caused by the surface of the food 40 or wrapping of the food 40, and the positional deviation of the food 40 when the food 40 is placed on the belt conveyor. As illustrated in FIG. 6, the control device 14 controls the operations of the right arm 13 to align the right hand part 18 (position of the wrist part 17) near directly above a terminal end of the first belt conveyor 51. Then, the right hand part 18 (the elevating part 17a of the wrist part 17) is lowered so that the contact surfaces 32a of the pair of holding members 32 located at a right end contact the side surfaces 40c of the food 40 located to a leading end on the first belt conveyor 51 (see FIG. 4). By the operation of the actuator member 33, the holding members 32 at the right end reduce the mutual gap to pinch and hold the food 40 at the leading end.

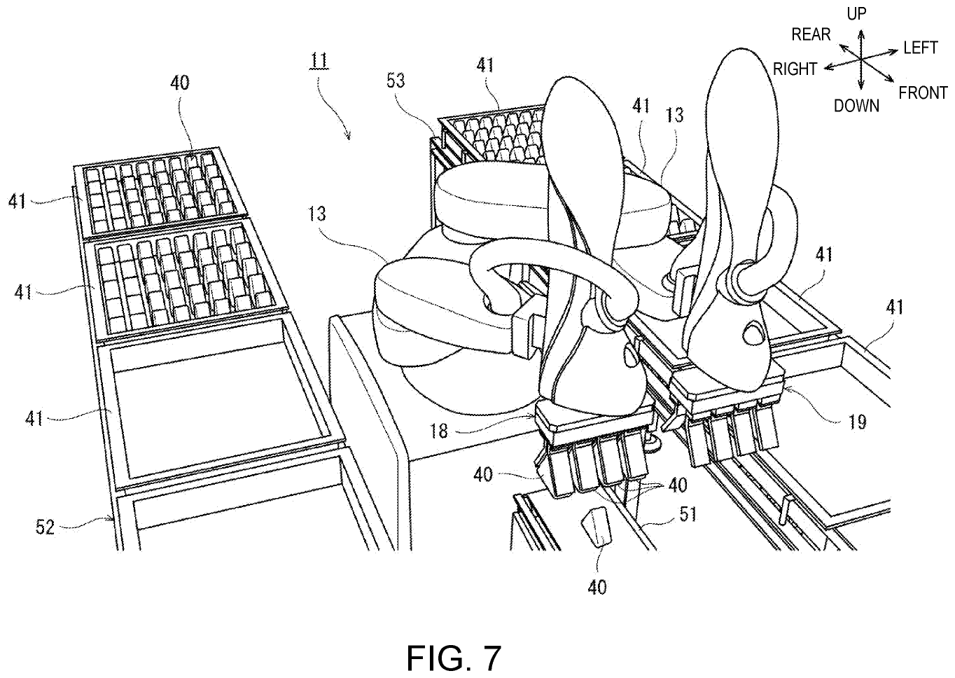

Next, where the food 40 is held by the holding members 32 at the right end, the elevating part 17a of the wrist part 17 is raised to a given position. The wrist part 17 is moved horizontally by a distance corresponding to a width of one piece of food 40 in the first direction. Here, the first belt conveyor 51 periodically operates by an amount corresponding to a length of one piece of food 40 in the second direction. That is, the first belt conveyor 51 is configured to operate interlocking with the operations of the robot 11. Then, the right hand part 18 (the elevating part 17a of the wrist part 17) is again lowered so that, by the holding members 32 which are the second from the right, the contact surfaces 32a of the second holding members 32 contact the side surfaces 40c of the food 40 at the leading end on the first belt conveyor 51. By the operation of the actuator member 33, the second holding members 32 reduce the mutual gap to pinch and hold the second food 40. By repeating the above operations, as illustrated in FIG. 7, the four pieces of foods 40 are held by the four holding members 32.

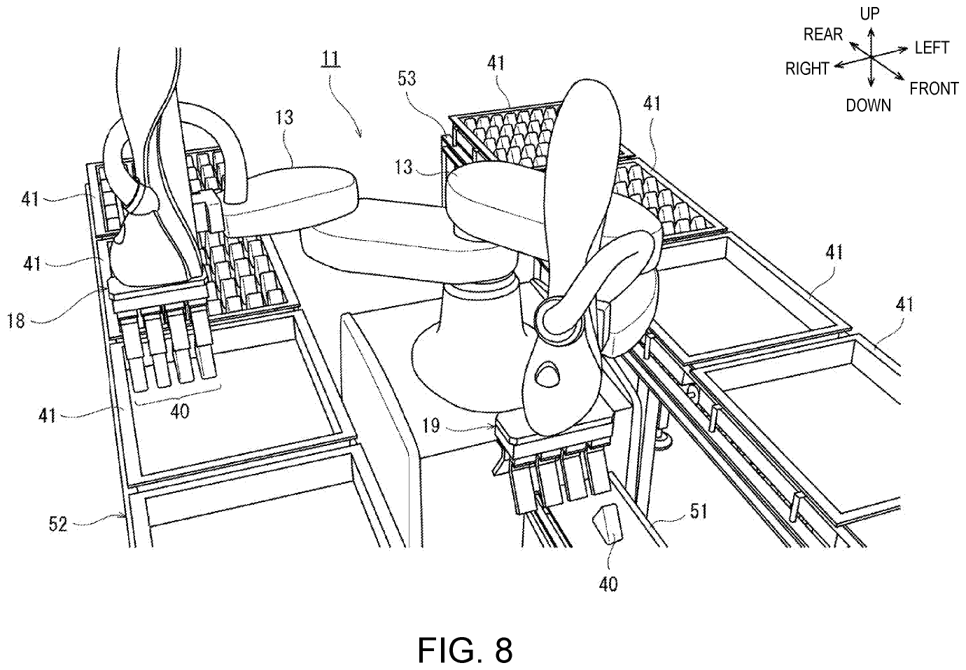

And as illustrated in FIG. 8, the robot 11 packs the four pieces of foods 40 held by the right hand part 18 into the tray 41 on the second belt conveyor 52 located at the right side of the robot 11. During the series of operation of the right arm 13, the left arm 13 is standing by above the first belt conveyor 51 in order to prepare for the holding operation of the food 40. Then, by repeating a series of operation similar to the right arm 13, the left arm 13 also holds four pieces of foods 40, and packs the four pieces of foods 40 held by the left hand part 19 into the tray 41 on the third belt conveyor 53 located at the left side of the robot 11.

Therefore, according to this embodiment, since each of the four pairs of the holding members 32 operates independently so as to pinch each of the four pieces of foods 40 from both sides in the first direction, the four pieces of foods 40 can be certainly held in the state where the foods 40 are line up in the first direction, by repeatedly performing the holding operation by each pair of holding members 32 for the each of the four pieces of foods 40 lined up in the second direction perpendicular to the first direction in the standing state where the front surfaces 40a face in the first direction. Thus, the efficiency of the packing work of the foods can be improved in the limited workspace.

### (Modification)

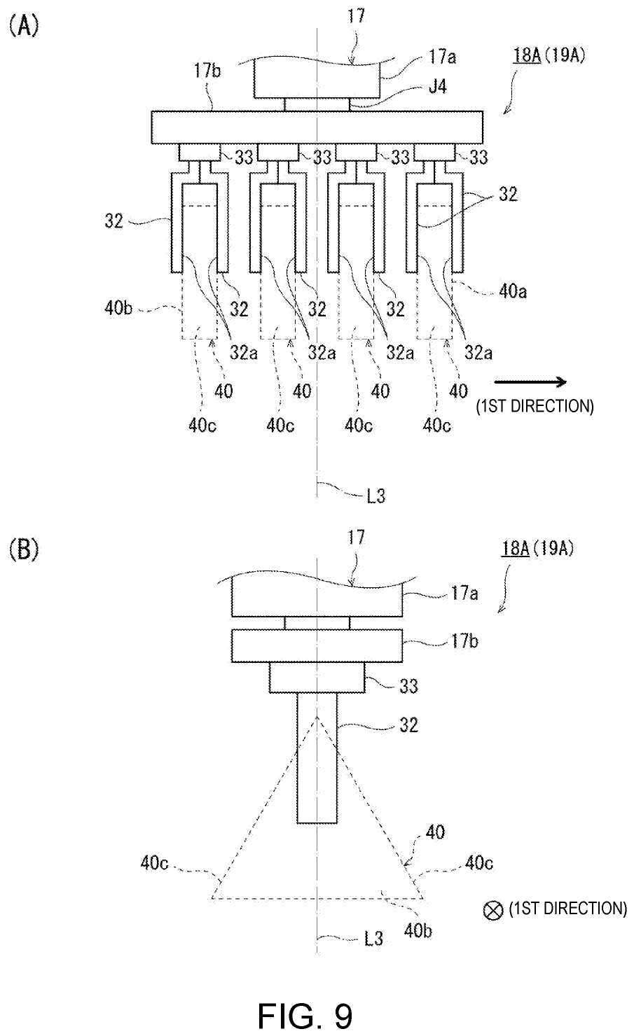

Next, one modification of the hand part 18 (holding part) of the robot 1 of this embodiment is described using a front view and a side view of FIGS. 9(A) and 9(B). The fundamental structure of a hand part 18A of this modification is similar to that of the first embodiment (FIG. 4). Below, description of the structures common to the first embodiment is omitted, and only different structures will be described. As illustrated in FIG. 9, although each pair of holding members 32 of this modification is also constructed so as to pinch the food 40 from both sides in the standing state where the front surface 40a faces in the first direction, each pair of holding members 32 is constructed in this modification so as to pinch the front surface 40a and the rear surface 40b of the food 40 from both sides. Each holding member 32 has a contact surface 32a which has the shape corresponding to the front surface 40a and the rear surface 40b of the food 40, and contacts the food 40. The holding member 32 may have, for example, a rectangular flat-plate shape, and has two opposite flat primary surfaces, and one of the primary surfaces is the contact surface 32a which contacts the front surface 40a or the rear surface 40b of the food 40 held by the holding members 32. For example, a resin plate or a metal plate may be used for the material of the holding member 32.

Here, the actuator member 33 also operates the pair of holding members 32. The actuator member 33 is connected to an actuator (not illustrated) etc., and is connected to the upper end side of the pair of holding members 32 so that the pair of holding members 32 moves linearly to change their mutual gap. By this actuator member 33, the pair of holding members 32 reduce the mutual gap to pinch and hold one piece of food 40. Although in this modification each food 40 is held by a frictional force generated when the contact surface 32a of the holding member 32 contacts the front surface 40a or the rear surface 40b of the food 40, suction port(s) may be formed in the contact surface 32a to hold the food 40 by a suction force.

### (Other Embodiments)

Note that, although in the above embodiment the right hand part 18 and the left hand part 19 respectively have the structure to collectively hold the four pieces of foods 40, they may respectively have a structure to hold two or three pieces of foods 40 by changing the number of holding members 32 provided in the first direction, or may have structure to hold five or more pieces of foods 40.

Note that, although in the above embodiment the case where the holding device 10 for the foods 40 according to the present disclosure is comprised of the dual-arm robot having the pair of robotic arms 13 is described, the holding device 10 may be comprised of a single-arm robot having one robotic arm 13.

Note that, although in the above embodiment the number of the first belt conveyor 51 is one, the number may be two or more. For example, when the foods 40 are conveyed on two first belt conveyors 51, one of the arms 13 may be operated to hold a plurality of foods 40 on one of the conveyors (51), and the other arm 13 may hold a plurality of foods 40 on the other conveyor (51).

Note that, although in the above embodiment the holding device 10 for the foods 40 is used for the packing work of the plurality of foods 40 into the tray 41, the work may be other works, which require the holding of the plurality of foods 40.

It is apparent for a person skilled in the art that many improvements and other embodiments of the present disclosure are possible from the above description. Therefore, the above description is to be interpreted only as illustration, and it is provided in order to teach a person skilled in the art the best mode that implements the present disclosure. The details of the structures and/or the functions may substantially be changed without departing from the spirit of the present disclosure.

### INDUSTRIAL APPLICABILITY

The present disclosure is useful for the holding device for foods when packing the foods into the tray.

### DESCRIPTION OF REFERENCE CHARACTERS

10 Holding Device

11 Robot

13 Arm

14 Control Device

17 Wrist Part

18 Right Hand (Holding Part)

19 Left Hand (Holding Part)

32 Holding Member

33 Actuator Member

40 Food

41 Tray

51 First Belt Conveyor

52 Second Belt Conveyor

53 Third Belt Conveyor

1. A holding device for foods configured to hold self-standable foods each having a front surface and a rear surface parallel to the front surface, comprising:
a holding part configured to hold the foods in a standing state where the front surfaces face in a first direction and in a state where the foods are lined up in the first direction, the holding part including a plurality of pairs of holding members each configured to pinch each of the foods from both sides in the first direction, and actuator members each configured to independently operate each of the pairs of holding member.

2. The holding device of claim 1, further comprising:
a base; and
a robotic arm configured to be movable with respect to the base, and provided at a tip end thereof with the holding part,
wherein the holding device holds the foods in the state where the foods are lined up in the first direction by repeating, in a workspace of the robotic arm, a holding operation by each of the pairs of holding members to the each of the foods lined up in a second direction perpendicular to the first direction in the standing state where the front surfaces face in the first direction.
